(19) United States
(12) Patent Application Publication
(10) Pub. No.: US 2005/0260892 A1
(43) Pub. Date: Nov. 24, 2005

(54) Low profile card connector

(75) Inventor: Shigeru Sato, Chiba-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAMAICHI ELECTRONICS CO., LTD.

(21) Appl. No.: 11/134,458

(22) Filed: May 23, 2005

(30) Foreign Application Priority Data
May 24, 2004 (JP) 2004-153735

(51) Int. Cl. H01R 11/22

(52) U.S. Cl. 439/630

(57) ABSTRACT

A low profile card connector includes a connector housing, a cover member, a card storage space that is inserted with a card, a contact that is provided in a cantilever-like manner, a guide member that guides a face having a pad of the card, a retention member that guides a face having no pad of the card, and a contact displacement space in which the tip end of the contact is displaced. When a pad section has the nominal thickness “A” mm and the interval between the apex of the contacting section of the contact and the card rettention member is “C” mm, the contact displacement space has the thickness “F” mm that is set to be within a range of F=A−C+0.2 to F=A−C+0.5.

This application claims priority from Japanese Patent Application No. 2004-153735 filed May 24, 2004, which is hereby incorporated by reference herein.

### BACKGROUND OF THE INVENTION

1. Field of the Invention

The present invention relates to a low profile card connector. In particular, the present invention relates to a low profile card connector in which a part of a housing fixed with a contact in which the contact is displaced has a thickness that can be reduced as much as possible.

2. Description of the Related Art

In a card connector, a contact having an electrical contact with a pad as an external terminal of a card inserted to the card connector has elasticity. The elasticity allows, when the card is inserted to the card connector, a contacting section of the contact to be displaced in a lower direction for example and the reactive force causes the contacting section of the contact to be contacted with a pad of the card with a predetermined contact pressure. To provide this, the contact housing needs a space therein so that the contacting section of the contact, in particular contact tip end, can be displaced in a lower direction.

Recently, in electronic devices attached with a card connector (e.g., digital camera, cellular phone, notebook computer, video cartridge recorder), a card inserted to the card connector has been provided with a smaller size. In accordance with this, the card connector itself has been provided with a smaller size. The card connector in particular has been required to have a low profile due to a card having a thinner thickness. Due to this reason, the connector housing has no more space for absorbing the displacement of the contacting section of the contact and the contact tip end consequently and thus a hole penetrating a bottom wall of the connector housing has been provided to secure this space (See Japanese Patent Application Laid-Open No. 2003-217741).

By the way, when the tip end of the contact is positioned above an upper face of a guide member for guiding the card, the front face of the card is abutted with the contact tip end, thus causing a risk in which the contact may be deformed or the card may be damaged. In order to prevent this, the contact needs to be provided so that the contact tip end is positioned below the upper face of the guide member.

Conventionally, the lower part from the upper face of the guide member for guiding the card is used as a space part including the hole penetrating the bottom wall of the connector housing in which the contact tip end is displaced. When the space section has a size or thickness that is sufficient to be larger than the amount of the displacement of the contact, there is no particular problem. However, the card connector having a low profile involved with the above issue of the position of the contact tip end makes it very difficult to design the thickness of the space section including such a penetrating hole in which the contact tip end is displaced. Specifically, when the space section has an excessively thin thickness, the contact tip end protrudes, with the displacement of the contacting section of the contact in a lower direction, from the bottom face of the connector housing via the penetrating hole and is abutted with an electronic device to which the card connector is attached. This causes a risk in which the contact tip end may be bent or the contact tip end may damage a print circuit provided in the electronic device. An excessively large space section causes the height of the entire card connector to be high, thus substantially preventing the card connector from having a low profile.

In view of the problem as described above, it is an objective of the present invention to provide a low profile card connector in which the space section can be designed easily so that the size of the space section (thickness) in which the contact tip end is displaced can be minimized based on the thickness of the pad section in which the pad of the card to be inserted is formed.

### SUMMARY OF THE INVENTION

In order to achieve the above objective, the low profile card connector according to the present invention comprises a connector housing, a cover member for covering the contact housing, a card storage space that is formed by the connector housing and the cover member and that is inserted with a card, a plurality of contacts that are provided in the card storage space in a cantilever-like manner, a guide member that is provided in the card storage space and that guides a face having a pad of a pad section of the card having a pad having an electrical contact with a contacting section of the contact, a card retention member that is provided in the card storage space and that guides a face having no pad of the pad section of the card, and a contact displacement space that is provided at the lower side of the upper face of the guide member and in which the tip end of the contact is displaced. In the low profile card connector according to the present invention, when the pad section has a nominal thickness “A” mm and the interval between the apex of the contacting section of the contact and the card retention member is “C” mm, the contact displacement space has the thickness “F” mm that is set to be within a range of F=A−C+0.2 to F=A−C+0.5.

The nominal thickness of the pad section may be equal to or smaller than the thickness of the entire card.

The present invention has the structure as described above. Thus, the contact tip end is prevented from being abutted with the front face of the inserted card, therefore the contact is not deformed. The contact tip end is also prevented from being protruded in a lower direction from the space in which the contact is displaced and from being abutted with an electronic device, therefore the contact is not deformed or does not damage an electric circuit provided in the electronic device.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a top view illustrating a card connector according to the present invention to which a card having a pad concave section is inserted;

FIG. 2 is an enlarged perspective view of the card connector of FIG. 1 except for a cover member in which a part of the card connector in which a contact is provided is shown;

FIG. 3 is a schematic cross sectional view of the card connector shown in FIG. 1; and

FIG. 4 is a schematic cross sectional view of another card connector different from that of FIG. 1 to 3 in which is inserted with a flat card having no pad concave section.

### DETAILED DESCRIPTION OF THE PREFERRED EMBODIMENTS

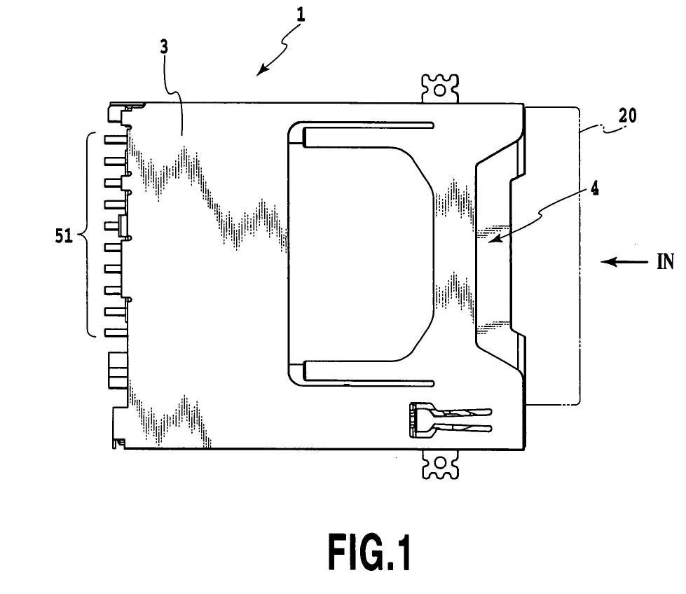

First, with reference to FIGS. 1 to 3, the outline of the card connector will be described.

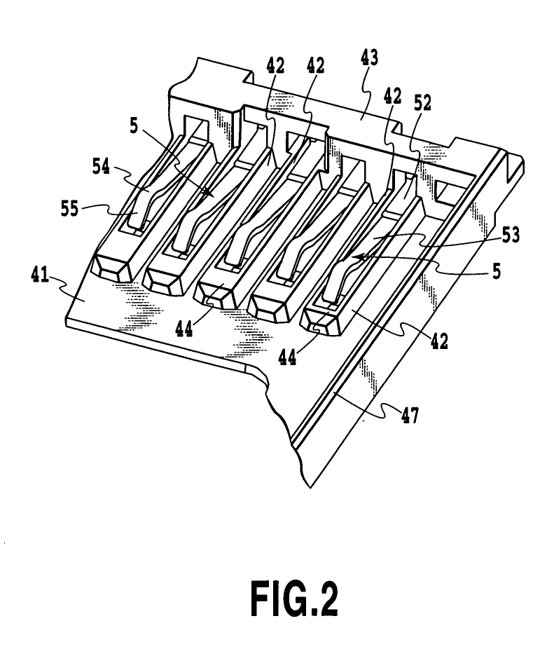

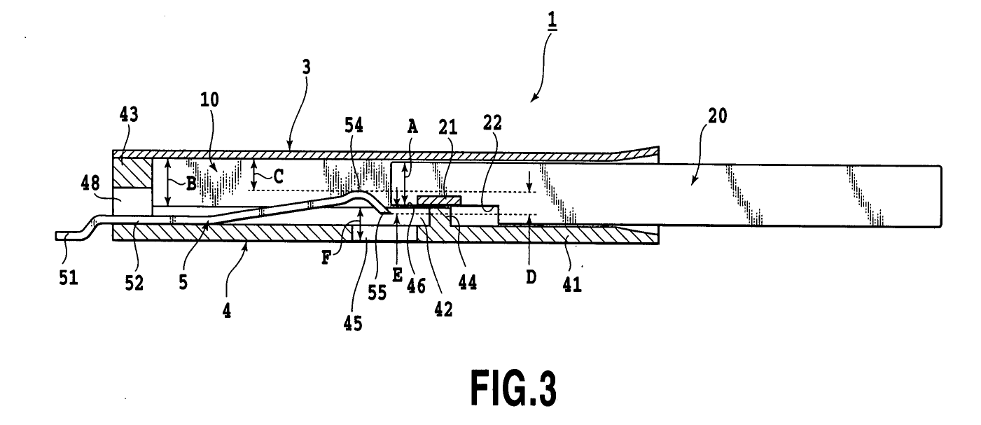

FIG. 1 is a top view illustrating a card connector according to the present invention. FIG. 2 is an enlarged perspective view except for a cover member in which a part of the card connector in which a contact is provided is shown. FIG. 3 is a schematic cross sectional view of the card connector to which a card having a pad concave section is inserted.

The card connector 1 generally at least includes the cover member 3, the housing member 4, and the plurality of contacts 5. The cover member 3 is made of a thin plate-like metal material and has a substantially channel-like shape. The housing member 4 is integrally molded by a resin material for molding. The contact 5 is provided by phosphor bronze for a spring and is fixed to the housing member 4 so that the contact 5 is parallel to the housing member 4 in a cantilever-like manner.

The housing member 4 includes the bottom wall 41, the pair of side walls 47 at both sides of the bottom wall 41; and the rear wall 43 to which the contact 5 penetrates and is pressed to be fixed. The housing member 4 is covered by the cover member 3 to define the card storage space 10 (see FIG. 3).

The rear wall 43 of the housing member 4 includes the plurality of attachment openings 48 to which the respective contacts 5 are pressed in and fixed. A pair of longitudinal walls 42, 42 are provided at both sides of the attachment opening 48 to sandwich the attachment opening 48 so that the longitudinal walls 42, 42 are parallel to the side wall 47 of the housing member 4 and so that the longitudinal walls 42, 42 are integrated with the rear wall 43 and the bottom wall 41. The pair of longitudinal walls 42, 42 at the front part are coupled with the similarly integrated lateral walls 44. These pairs of longitudinal walls 42, 42 and the lateral walls 44 define spaces in which the contact 5 is respectively provided (contact installation spaces). The upper faces of the pair of longitudinal walls 42, 42 and the lateral wall 44 provide the guide face 46 for guiding the pad concave section 22 of the card 20 (see FIG. 3). Specifically, the pairs of longitudinal walls 42, 42 and the lateral walls 44 function as a guide member for respectively guiding the pad concave sections 22 of the card 20. As can be understood from this, the heights of the longitudinal walls 42, 42 and the lateral wall 44 substantially correspond to the depth of the pad concave section 22 of the card 20 (which will be described later) while the length of the pair of longitudinal walls 42, 42 (the length from the rear wall 43 to the lateral wall 44) substantially corresponds to the length of the pad concave section 22. In order to secure a space in which the tip end 55 of the contact 5 is displaced, the penetration hole 45 is provided in the vicinity of the lateral wall 44 through the bottom wall 41 of the housing member 4 (see FIG. 3). Specifically, the space in which the contact 5 can be displaced (contact displacement space) is provided between the guide face 46 and the bottom face of the card connector 1. The neighboring attachment opening 48 is also provided with a similar contact installation spaces so that the attachment opening 48 is parallel to the contact installation spaces.

As shown in FIGS. 2 and 3, the contact 5 includes a terminal section 51 connected to a print circuit of the electronic device, the fixation section 52 pressed into the attachment opening 48 of the housing member 4, the elastic section 53 that may be elastically deformed, the contacting section 54 that is upwardly bent to have a convex shape and that is contacted to the pad 21 of the card 20, and the tip end 55. The contact 5 is provided by being punched out of the thin plate of phosphor bronze for a spring, as described above. In this embodiment, the contact 5 is fixed in a cantilever-like manner so as to rise from the bottom wall 41 of the housing member 4. Thus, when the card 20 is inserted to the card connector 1, the contacting section 54 of the contact 5 is displaced in the lower direction.

The card connector 1 at least includes the structure as described above. Although the card connector 1 includes components other than those described above (e.g., eject mechanism for assisting the insertion and removal of a card), such components are not related to the present invention and thus will not be described further.

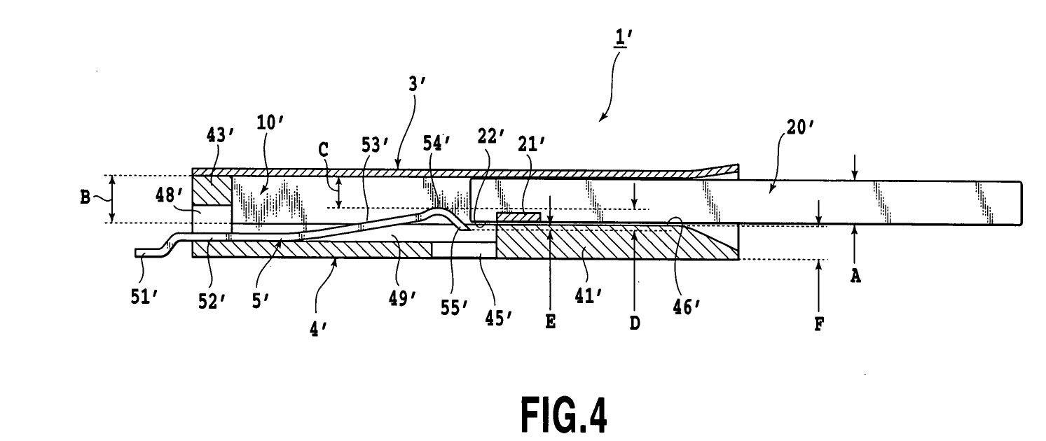

Next, the setting of an optimal height of the contact displacement space according to the present invention will be described with reference to FIGS. 3 and 4. As described above, FIG. 3 is a schematic cross sectional view of a card connector to which a card having a pad concave section sucu as reduced size multi media card (RS MMC), i.e., a card in which the thickness of a part having the pad is smaller than the thickness of the entire card, is inserted. FIG. 4 is a schematic cross sectional view of a card connector different from FIG. 3 to which a flat card having no pad concave section such as mini secure digital card (mini SD), i.e., a card in which the thickness of a part having the pad is equal to the thickness of the entire card, is inserted. Specifically, in the card connector 1′ shown in FIG. 4, the contact 5′ is provided, in a cantilever-like manner, in the groove section 49′ provided in the bottom wall 41′ of the housing member 4′. The flat card 20′ inserted to the card connector 1′ is inserted between the lower face of the cover member 3′ as a card retention member for guiding the card 20′ (upper face of the card) and the upper face (guide face) 46′ of the bottom wall 41′ as a guide member for guiding the card 20′ (lower face of the card). Thus, the card connector 1′ shown in FIG. 4 is substantially different from card connector 1 shown in FIGS. 1 to 3 in these points. Components in FIG. 4 corresponding to those of FIGS. 1 to 3 are denoted with reference numerals having “′(single quotation mark)”.

In FIGS. 3 and 4, “A” represents the nominal thickness of the card 20, 20′ of a part at which the pad 21, 21′ as an external terminal of the card 20, 20′ inserted to the card connector 1, 1′ is formed (in the embodiment of FIG. 3, the pad concave section 22 corresponds to this and this part will be hereinafter referred to as “pad section”). The reference numeral “B” represents the height of the card storage space 10, 10′ of the card connector 1, 1′ of a part in which the pad section of the card 20, 20′ is stored and in which the pad 21, 21′ is contacted with the contact 5, 5′ provided in the card connector 1, 1′. Specifically, the reference numeral “B” represents the interval between the upper face of the pad section of the card, i.e., the lower face of the card retension member (in this embodiment, cover member 3, 3′ corresponds to this) for guiding the face having no pad of the card section, and the lower face of the pad section of the card, i.e., the guide face 46, 46′ for guiding the face 22, 22′ having the pad. The reference numeral “C” represents the interval between the lower face of the card retention member of the card storage space 10, 10′ and the apex part of the curved contacting section 54, 54′ of the contact 5, 5′ and is calculated by the nominal displacement amount of the contact for obtaining a desirable contact pressure. The reference numeral “D” represents the vertical distance from the apex part of the contacting section 54, 54′ of the contact 5, 5′ to the tip end section 55, 55′ of the contact 5, 5′. The reference numeral “E” represents the vertical distance (margin) between the guide face 46, 46′ for guiding the lower face of the pad section and the contact tip end 55, 55′ extended into the contact displacement space at the lower side of the guide face 46, 46′. The reference numeral “F” represents the thickness (height) of the contact displacement space to be set.

The thickness A of the pad section of the card 1, 1′ is approved to have the tolerance of ±0.1 mm according to a standard. Thus, it is understood that the thickness B of the card storage space 10, 10′ can provide the storage of the card 1, 1′ when the height B has a margin of 0 to 0.1 mm to the maximum thickness of the card (A+0.1). Specifically, the following formula is established.
B=A+0.1+(0 to 0.1) (1)

As can be understood from FIGS. 3 and 4, the following formula is established.
B=C+D−E (2)

The interval C may have the assembly tolerance of ±0.1 mm according to the standard. In order to prevent the contact 5, 5′ from being protruded from the bottom face of the card connector 1, 1′, a case in which the contact 5, 5′ may be displaced with the maximum distance may be considered. Thus, the interval C₀ in this case is represented as follows.
C₀=C−0.1 (3)

Next, the vertical distance E along which the tip end 55, 55′ of the contact 5, 5′ is extended into the contact displacement space is given as follows.
E=0 to 0.2 mm (4)

Specifically, when the distance E has a negative value equal to or lower than 0 mm as the lower limit (which means that the tip end 55, 55′ of the contact 5, 5′ is above the guide face 46, 46′), then the front face of the card 20, 20′ is abutted with the tip end 55, 55′ and the contact 5, 5′ is bent in the front-and-rear direction, causing a risk in which the displacement in the up-and-down direction otherwise possible may be prevented. When the distance E has a value equal to or higher than the upper limit of 0.2 mm, the contact displacement space must be increased in order to prevent the contact from being protruded from the connector bottom face, which is not suitable for the objective for providing a low profile card connector.

By the way, it is understood that the conditions of the thickness F of the contact displacement space are “F≧D” according to which the tip end 55, 55′ of the contact 5, 5′ is prevented from being protruded from the bottom face of the card connector. From this, it is understood that the minimum value of the thickness F of the contact displacement space, which is represented as
F=D (5)
is the most desirable thickness of the contact displacement space so that the card connector can have a low profile.

When the relations of the formulae (1) to (4) are substituted for the formula (5) to calculate “F”, the following result is obtained.

$$\begin{matrix}F = B - {C}_{0} + E \\ = [ A + 0.1 + ( 0 to 0.1 ) ] - ( C - 0.1 ) + ( 0 to 0.2 ) \\ = A - C + ( 0.2 to 0.5 )\end{matrix}$$

As described above, the thickness F of the optimal contact displacement space may be set to have a value in the range of:
F=A−C+0.2 to A−C+0.5

It is clear that the value of (A−C) corresponds to the nominal displacement amount of the contact. This value (A−C) is calculated based on the spring constant of the contact and the contact pressure between the contact and the pad. Thus, the thickness F of the optimal contact displacement space may have a value obtained by adding 0.2 to 0.5 mm to the nominal displacement amount of the contact.

For example, it is understood that the thickness F of the contact displacement space, when a flat card (e.g., RS MMC card) has the nominal thickness of the card pad section of 1.2 mm and the nominal displacement amount of the contact is 0.35 mm (i.e., C=0.85 mm), may have a value in the range of 0.55 to 0.85 mm. Alternatively, the thickness F of the contact displacement space, when a card such as mini SD card has the nominal thickness A of the card pad section of 1.4 mm and the nominal displacement amount of the contact is 0.35 mm (i.e., C=1.05 mm), may have a value similarly in the range of 0.55 to 0.85 mm.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes.

1. A low profile card connector, comprising:
a connector housing;
a cover member for covering the contact housing;
a card storage space that is formed by said connector housing and said cover member and that is inserted with a card;
a plurarity of contacts that are provided in the card storage space in a cantilever-like manner;
a guide member that is provided in the card storage space and that guides a face having a pad of a pad section having a pad having an electrical contact with a contacting section of the contact;
a retention member that is provided in the card storage space and that guides a face having no pad of the pad section of the card; and
a contact displacement space that is provided at the lower side of the upper face of the guide member and in which the tip end of the contact is displaced,
wherein:
when the pad section has a nominal thickness “A” mm and the interval between the apex of the contacting section of the contact and the card retention member is “C” mm, the contact displacement space has the thickness “F” mm that is set to be within a range of F=A−C+0.2 to F=A−C+0.5.

2. The low profile card connector as claimed in claim 1, wherein the nominal thickness of the pad section is equal to the thickness of the entire card.

3. The low profile card connector as claimed in claim 1, wherein the nominal thickness of the pad section is smaller than the thickness of the entire card.
